(19) United States
(12) Patent Application Publication
(10) Pub. No.: US 2008/0168940 A1
(43) Pub. Date: Jul. 17, 2008

(54) Medicine cap counter device

(76) Inventors: Lisa A. Duer, Woodstock, GA (US); Ravi Y. Navare, Mableton, GA (US)

Correspondence Address: H. LEON ENTERPRISES, INC., 924 BOWEN ST. NW, ATLANTA, GA, 30318, US

(21) Appl. No.: 11/652,420

(22) Filed: Jan. 11, 2007

(51) Int. Cl. G09F 9/00

(52) U.S. Cl. 116/324

(57) ABSTRACT

A device mountable on a medicine container for indicating whether a pill has been taken, which includes a set of keys and a plurality of open grooves with rounded ends. Atop the elongated base of each key is a small protrusion, which, like each groove, is generally oval in shape. In assembled relation, each protrusion is slip-fitted into one of the grooves. Slideable along the length of the groove, the protrusion, while it abuts one or the other groove end, is held temporarily in one of two distinctive positions. In view through an elongated portion of the groove not occupied by the protrusion is only one of two distal ends of the elongated base—provided the protrusion abuts a groove end—and the distal end's distinctive indicator marking. By sliding one protrusion to the opposing groove end after each use, a patient can easily record his pill consumption.

### BACKGROUND OF THE INVENTION

Many times persons taking medications need to be reminded to take their medicine. In the prior art, a need exists for a low cost, easy-to-use device which can be fitted onto a medicine container and used to inform a patient as to whether he/she has taken his/her pills.

### SUMMARY OF THE INVENTION

The object of this invention is to provide a low cost indicating device which can be mounted on a container holding medication and reset each time the user withdraws medicine from the container so as to aid her in determining whether she has taken the medicine in the amounts prescribed by her physician. This device is particularly useful when the same medication needs to be taken several times a day.

In accordance with the present invention, there is provided a device which comprises a structure in which is defined a plurality of generally oval-shaped grooves and a set of keys with elongated bases. Atop the midsection of each key is a generally oval-shaped protrusion which is narrower in width and substantially shorter in length than the elongated base of the key so that the base extends both laterally and longitudinally from beneath the protrusion.

In assembled relation, the protrusion is slip-fitted into one of the grooves and can be slid back and forth manually along the longitudinal centerline of the groove. The travel of the protrusion is limited by its abutment with one or the other end of the groove. Means for temporarily holding the protrusion in abutment with a groove end includes a bump on the elongated base and a pair of spaced apart notches for engaging the bump. The notches, which are defined by the structure, are disposed transversely to the longitudinal centerline of the groove.

In the preferred embodiment, each key alternately exhibits one of two distinctive positions depending upon which end of the groove the protrusion, at any given time, is abutting. Specifically, only the first distal end of the elongated base is visible through the groove when the protrusion abuts the second end of the groove. Likewise, when the protrusion abuts the first end of the groove, only the second distal end of the elongated base is so visible. Moreover, the first distal end bears a symbol to remind a user that a pill needs to be taken; and the second distal end a symbol indicating that the pill has been taken. Suitable indicator symbols include “NO” and “YES” (in any language) or a pair of icons. Alternately, color coding can be utilized.

Preferably, the structure defining the plurality of oval-shaped grooves is a cap with a cylindrical sidewall and forms part of the closure means of the medicine container. Fitted within the cylindrical sidewall is a disc whose upper surface serves as a bearing on which the elongated-bases of the keys can be slid. Pushing the disc against the keys is a diaphragm which is held in place by a series of protrusions extending inwardly from the cylindrical sidewall.

Alternately, the structure defining the plurality of oval-shaped grooves can be mounted on a standard cap removably engageable with the medicine container or can be attached to the side of the medicine container itself.

### BRIEF DESCRIPTION OF THE DRAWINGS

FIG. 1 is a perspective view of the medicine cap counter device according to the present invention;

FIG. 2 is a top plan view of the counter device according to FIG. 1;

FIGS. 3 and 4 are side and front elevational views, respectively, of the counter device according to FIG. 1;

FIG. 5 is a cross-sectional view of the counter device taken along line 5-5 of FIG. 2;

FIG. 6 is an exploded view of the counter device according to FIG. 1; and

FIG. 7 is a perspective view, on an enlarged scale, of one of the indicator keys in the counter device according to FIG. 1.

### DETAILED DESCRIPTION OF THE PREFERRED EMBODIMENT

In the drawings, an improved device for use in reminding a person to take his medicine is indicated generally by the reference numeral 10. The device 10 includes a set of elongated keys, a support structure 11, a disc 21 and a diaphragm 23. The structure 11 defines a plurality of grooves 12, 22, 32, 42, the distal ends of each of which are rounded and mirror images of each other, giving the edges of each groove a configuration which is herein referred to as an “oval shape”. Preferably doubling as a bottle cap, the structure 11 can be snap-fitted onto or otherwise temporarily secured to a medicine container (not shown) so as to form a removable closure means for it.

Each of the keys includes an elongated base 15 and a protrusion, both of which, like the grooves 12, 22, 32, 42, have rounded ends and are generally oval-shaped. Sized so that it can be slip-fitted into one of the grooves 12, 22, 32, 42, each protrusion 13 preferably measures about two-thirds the length of the groove and about one-half the length of the base 15.

Substantially wider in transverse cross-section than the protrusion 13 atop it, each elongated base 15 includes a pair of lateral extensions which are sandwiched between the underside of opposing edges of the groove 12, 22, 32, 42 into which the protrusion has been slip-fitted and a bearing surface 20 on the disc 21 (FIG. 5). Thus, as the protrusion 13 travels from one end of the groove 12, 22, 32, 42 to the other, upper surfaces on the lateral extensions and the lower surface of the base 15 slide against the underside of the structure 11 and across the bearing surface 20, respectively.

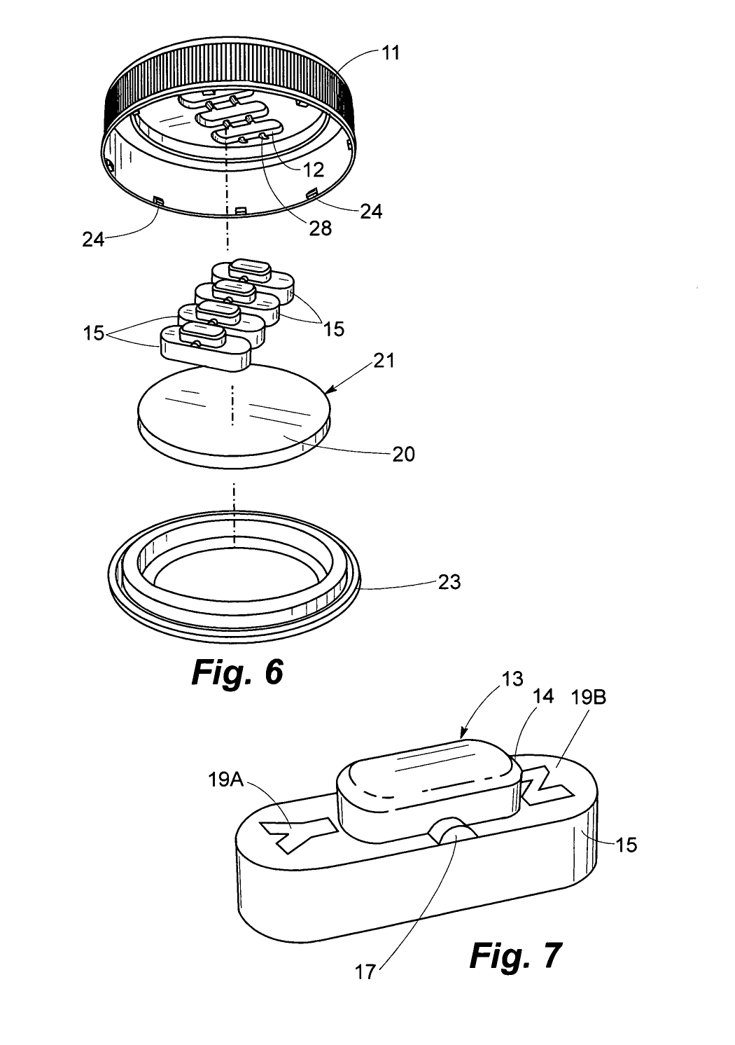

Means for temporarily holding the protrusion 13 in abutment with a groove end includes a pair of bumps 17 which extend upwardly from the lateral extensions of the base 15 and a pair of spaced apart notches 28 for engaging the bumps. Defined by the structure 11, the notches 28 so paired are disposed proximate with one of the groove ends on the underside of opposing edges of the groove 12, 22, 32, 42 and extend transversely to the longitudinal centerline of the groove (FIG. 6). Preferably, the distance separating the notches 28 in the pair proximate with each groove end is compatible with having the protrusion 13 abut said groove end at the same time the bumps 17 engage the notches in this proximate pair. In combination, the bumps 17 and notches 28 hold each of the protrusions 13 in one or the other of two distinctive positions in the grooves 12, 22, 32, 42.

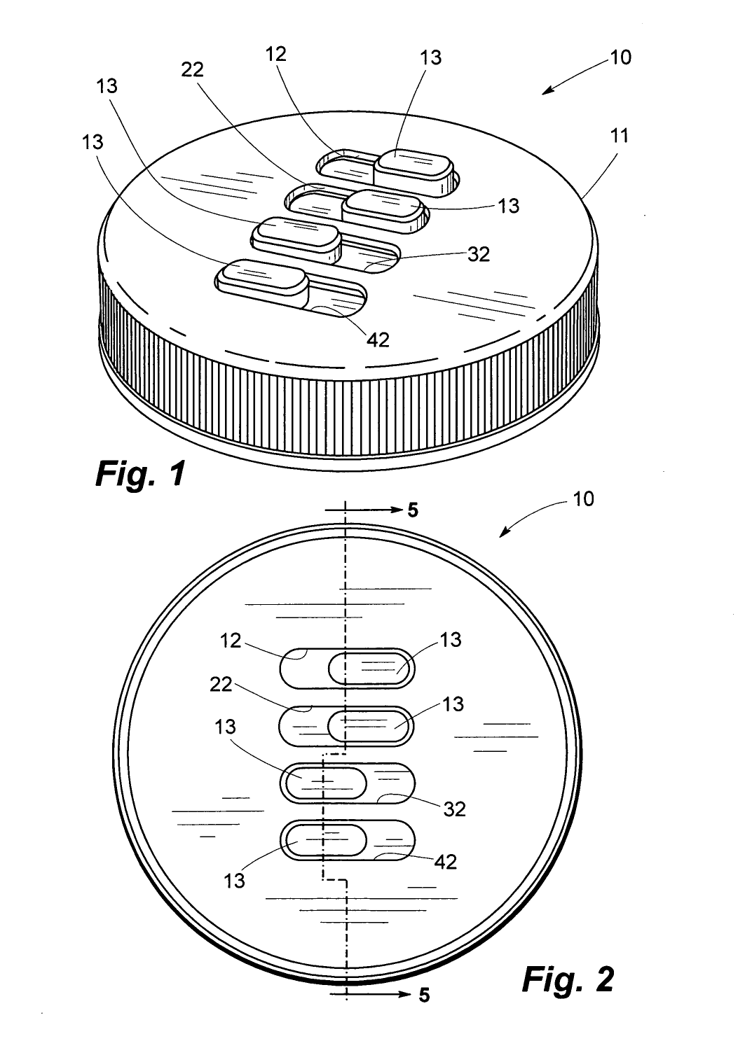

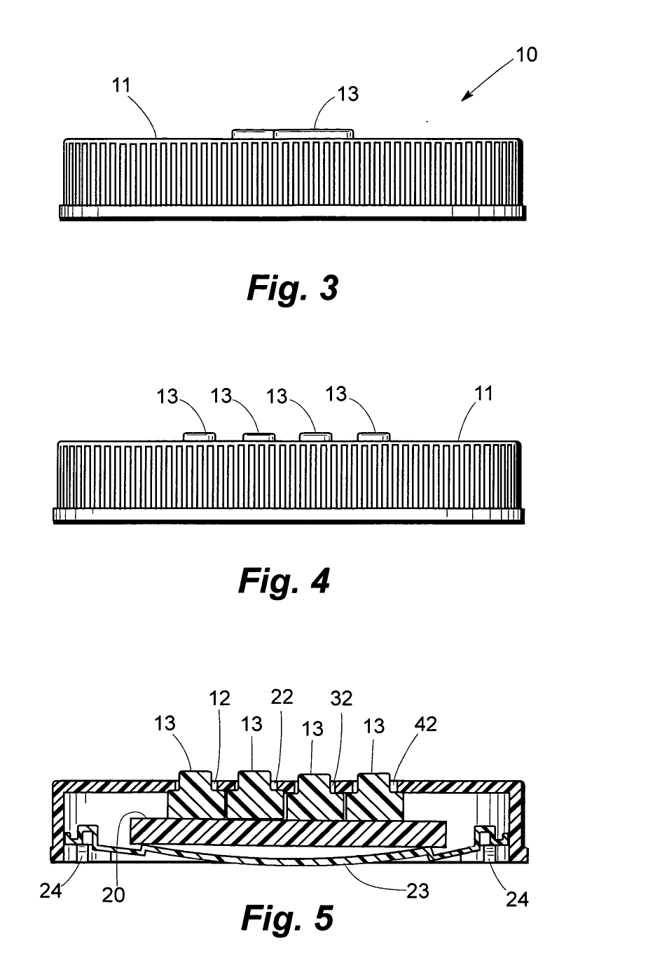

With each protrusion 13 in the preferred embodiment being about one-half as long as the base 15, only one of its distal ends 19A, 19B is visible through the groove 12, 22, 32, 42 when the protrusion, in assembled relation, abuts a groove end (FIGS. 1, 2 and 7). Suitable dimensions for the groove 12, 22, 32, 42 to accommodate a key whose protrusion 13 and base 15 measure, by way of example, 10 mm and 20 mm long, respectively, are 15 mm in length and 5 mm in width.

An indication that a pill has been taken is recorded with the device 10 by sliding one of the protrusions 13 from its abutment with the first end of a groove 12, 22, 32, 42 to an abutment with the second end of the groove. In FIG. 1, by way of illustration, the protrusions 13 in grooves 12 and 22 abut the second ends of their respective grooves, whereas the protrusions in grooves 32 and 42 remain in abutment with their first ends. In the latter situation, the second distal end 19B of the base 15, with its marking “N” or the like to stand for a pill not having been taken, is visible from outside through the groove 32, 42; and the first distal end 19A with its marking “Y” or the like (to show a pill has been taken) is hidden from view.

Alternately, the distal ends 19A and 19B can be color-coded to indicate that a pill either has or has not been taken, respectively. Again, to record that the medication has actually been taken, the patient or his caregiver needs to move the protrusion 13 on one of the keys so that its distal end 19B, which initially was on view through groove 12, 22, 32, 42, is slid out of view and only the distal end 19A of the key is exposed.

In the preferred embodiment, the structure 11 includes a cylindrical sidewall within which is fitted the disc 21 (FIGS. 5 and 6). Pushing the disc against the bases 15 of the keys is the diaphragm 23. The diaphragm 23 not only provides some spring action to hold the disc 21, the keys and the structure 11 in assembled relation but also serves as a seal when the device 10 is snap-fitted onto or otherwise temporarily secured to the medicine container. Holding the diaphragm 23 in place is a plurality of spaced apart protrusions 24 which extend inwardly from the cylindrical sidewall (FIGS. 5 and 6).

In an alternate embodiment, the cylindrical sidewall of the structure 11 terminates downwardly in a flange or plate (not shown), the underside of which has a self adhesive surface which can be used to affix it to a standard cap for the medicine container. A removable cover (not shown) can be used to protect the self adhesive surface until the device is ready for use.

What is claimed is:

1. A device for use with a medicine container from which pills can be dispensed, which comprises:
(a) a structure mountable on the container which defines a plurality of open grooves, each groove terminating distally in opposing first and second groove ends which are each rounded; and
(b) a set of keys, each key having an elongated base and a protrusion which is generally oval-shaped and extends upwardly from the midsection of the elongated base, the protrusion being narrower in width and substantially shorter in length than the elongated base so that the base extends both laterally and longitudinally from beneath the protrusion, the protrusion being slip-fitted into one of the grooves and being slideably back and forth along the longitudinal centerline of the groove, first and second distal ends of the elongated base each having a different indicator marking placed thereon; only the first distal end being visible through the groove when the protrusion abuts the second groove, and only the second distal end being visible through the groove when the protrusion abuts the first groove end, so that in use, distal ends of the elongated base of each key alternately exhibit one of two distinctive indicator markings depending upon which groove end the protrusion is abutting at any given time.

2. The device according to claim 1 which further comprises means for temporarily holding the protrusion in abutment with the second groove end, the holding means comprising a bump on the elongated base and a pair of spaced apart notches for engaging the bump; the notches, which are defined by the structure, being disposed transversely to the longitudinal centerline of the groove.

3. The device according to claim 1 which further comprises:
(a) a disc whose upper surface serves as a bearing on which the elongated bases of the keys can be slid; and
(b) means, including a diaphragm held in place by the structure, for pushing the disc against the elongated bases and portions of each elongated base against edges of the groove into which the protrusion has been slip-fitted.
